(19) United States
(12) Patent Application Publication
(10) Pub. No.: US 2024/0095642 A1
(43) Pub. Date: Mar. 21, 2024

(54) METHOD AND APPARATUS FOR COMPARING THE EFFICIENCY OF OPERATORS

(71) Applicant: PITT-OHIO Express, LLC, Pittsburgh, PA (US)

(72) Inventor: Justine A. Russo, Pittsburgh, PA (US)

(73) Assignee: PITT-OHIO Express, LLC, Pittsburgh, PA (US)

(21) Appl. No.: 17/945,603

(22) Filed: Sep. 15, 2022

(51) Int. Cl. G06Q 10/06; G06N 20/00

(52) U.S. Cl. CPC G06Q 10/06393; G06N 20/00

(57) ABSTRACT

An apparatus and method for comparing the efficiency of operators is disclosed. The apparatus including at least a processor and a memory containing instructions configuring the at least a processor to receive operator data, calculate a carbon emission rate of the at least an operator as a function of the at least a carbon emission datum, calculate a carbon efficiency score of the at least an operator as a function of the carbon emission rate, and generate an operator ranking as a function of the carbon efficiency score of the at least an operator.

### FIELD OF THE INVENTION

The present invention generally relates to the field of carbon efficiency. In particular, the present invention is directed to a method and apparatus for comparing the efficiency of operators

### BACKGROUND

With rising carbon emissions and increased global warmings, it is important to decrease carbon emissions. A large contributor to carbon emissions are the transportation and cargo industries. It can be difficult to calculate the carbon efficiency of an actor within these industries due to the diverse tasks that they may perform. Existing solutions to this problem are not sufficient.

### SUMMARY OF THE DISCLOSURE

In an aspect, an apparatus for comparing the efficiency of operators, the apparatus including at least a processor and a memory communicatively connected to the at least a processor, the memory containing instructions configuring the at least a processor to receive operator data, wherein the operator data includes at least an operator associated with at least a carbon emission datum. The memory also containing instructions further configuring the processor to calculate a carbon emission rate of the at least an operator as a function of the at least a carbon emission datum. The memory also containing instructions further configuring the processor to obtain a carbon efficiency score of the at least an operator as a function of the carbon emission rate. The memory also containing instructions further configuring the processor to generate an operator ranking as a function of the carbon efficiency score of the at least an operator.

In another aspect, a method for comparing the efficiency of operators, the method including receiving, by a processor, operator data, wherein the operator data comprises at least an operator associated with at least a carbon emission datum. The method further including calculating, by the processor, a carbon emission rate of the at least an operator as a function of the at least a carbon emission datum. The method further including obtaining, by the processor, a carbon efficiency score of the at least an operator as a function of the carbon emission rate. The method further including generating, by the processor, an operator ranking as a function of the carbon efficiency score of the at least an operator.

These and other aspects and features of non-limiting embodiments of the present invention will become apparent to those skilled in the art upon review of the following description of specific non-limiting embodiments of the invention in conjunction with the accompanying drawings.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 is a block diagram of an exemplary embodiment of an apparatus for comparing the efficiency of operators;

FIG. 2 is a block diagram of an exemplary embodiment of an operator database;

FIG. 3 is a block diagram of an exemplary embodiment of an apparatus for calculating a greenhouse gas ratio;

FIG. 4 is a diagram of an exemplary embodiment of a neural network;

FIG. 5 is a diagram of an exemplary embodiment of a node of a neural network;

FIG. 6 is a block diagram of an exemplary embodiment of a machine-learning module;

FIG. 7 is a flow diagram illustrating an exemplary embodiment of a method for comparing the efficiency of operators; and

FIG. 8 is a block diagram of a computing system that can be used to implement any one or more of the methodologies disclosed herein and any one or more portions thereof.

The drawings are not necessarily to scale and may be illustrated by phantom lines, diagrammatic representations and fragmentary views. In certain instances, details that are not necessary for an understanding of the embodiments or that render other details difficult to perceive may have been omitted.

### DETAILED DESCRIPTION

At a high level, aspects of the present disclosure are directed to systems and methods for comparing the efficiency of operators. In an embodiment, a carbon efficiency score for one or more operators may be calculated from one or more carbon emission rates. In an embodiment, carbon efficiency score may be calculated using a carbon efficiency machine-learning model.

Aspects of the present disclosure can be used to calculate a forecasted carbon efficiency score. In an embodiment, forecasted carbon efficiency score may be calculated using operator data and a forecasted task. In an embodiment, forecasted carbon efficiency score may be calculated using a forecast machine-learning model

Aspects of the present disclosure allow for the generation of an operator ranking based on carbon efficiency score and/or forecasted carbon efficiency score. In an embodiment, operator ranking may be used to choose an operator, which may be known as an operator selection. Exemplary embodiments illustrating aspects of the present disclosure are described below in the context of several specific examples.

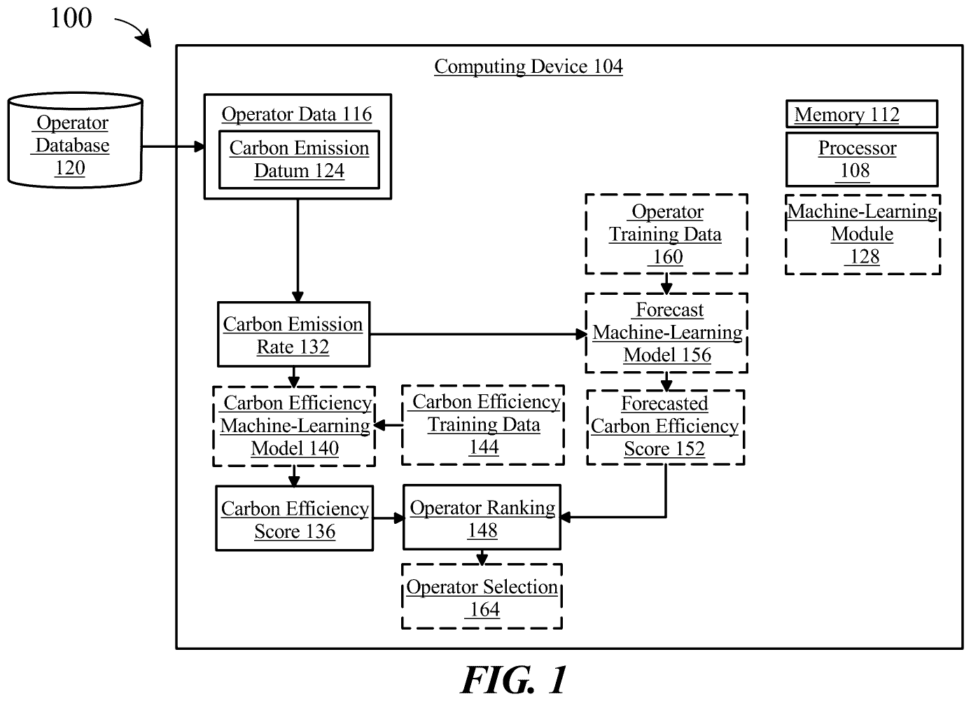

Referring now to FIG. 1, an exemplary embodiment of an apparatus 100 for comparing the efficiency of operators is illustrated. System includes a computing device 104. computing device 104 may include any computing device as described in this disclosure, including without limitation a microcontroller, microprocessor, digital signal processor (DSP) and/or system on a chip (SoC) as described in this disclosure. Computing device may include, be included in, and/or communicate with a mobile device such as a mobile telephone or smartphone. computing device 104 may include a single computing device operating independently, or may include two or more computing device operating in concert, in parallel, sequentially or the like; two or more computing devices may be included together in a single computing device or in two or more computing devices. computing device 104 may interface or communicate with one or more additional devices as described below in further detail via a network interface device. Network interface device may be utilized for connecting computing device 104 to one or more of a variety of networks, and one or more devices. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network may employ a wired and/or a wireless mode of communication. In general, any network topology may be used. Information (e.g., data, software etc.) may be communicated to and/or from a computer and/or a computing device. computing device 104 may include but is not limited to, for example, a computing device or cluster of computing devices in a first location and a second computing device or cluster of computing devices in a second location. computing device 104 may include one or more computing devices dedicated to data storage, security, distribution of traffic for load balancing, and the like. computing device 104 may distribute one or more computing tasks as described below across a plurality of computing devices of computing device, which may operate in parallel, in series, redundantly, or in any other manner used for distribution of tasks or memory between computing devices. computing device 104 may be implemented using a “shared nothing” architecture in which data is cached at the worker, in an embodiment, this may enable scalability of apparatus 100 and/or computing device.

With continued reference to FIG. 1, computing device 104 may be designed and/or configured to perform any method, method step, or sequence of method steps in any embodiment described in this disclosure, in any order and with any degree of repetition. For instance, computing device 104 may be configured to perform a single step or sequence repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. computing device 104 may perform any step or sequence of steps as described in this disclosure in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

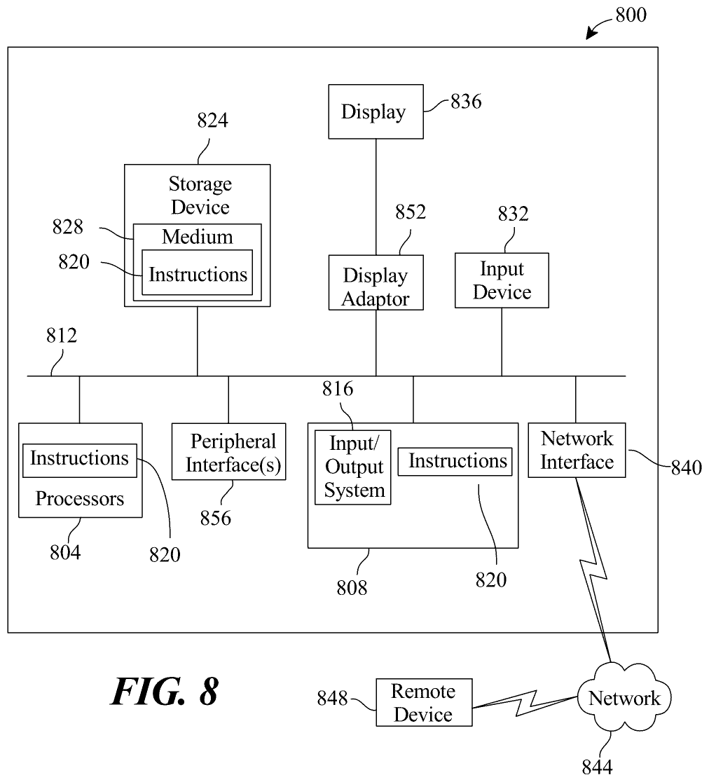

With continued reference to FIG. 1, apparatus 100 and/or computing device 104 includes at least a processor 108. The at least a processor 108 may be consistent with any processor discussed with reference to FIG. 8. Apparatus 100 and/or computing device 104 includes a memory 112 communicatively connected to the at least a processor 108, wherein the memory 112 contains instructions configuring the processor 108 to preform tasks in accordance with this disclosure.

With continued reference to FIG. 1, As used in this disclosure, “communicatively connected” means connected by way of a connection, attachment or linkage between two or more relata which allows for reception and/or transmittance of information therebetween. For example, and without limitation, this connection may be wired or wireless, direct or indirect, and between two or more components, circuits, devices, systems, and the like, which allows for reception and/or transmittance of data and/or signal(s) therebetween. Data and/or signals therebetween may include, without limitation, electrical, electromagnetic, magnetic, video, audio, radio and microwave data and/or signals, combinations thereof, and the like, among others. A communicative connection may be achieved, for example and without limitation, through wired or wireless electronic, digital or analog, communication, either directly or by way of one or more intervening devices or components. Further, communicative connection may include electrically coupling or connecting at least an output of one device, component, or circuit to at least an input of another device, component, or circuit. For example, and without limitation, via a bus or other facility for intercommunication between elements of a computing device. Communicative connecting may also include indirect connections via, for example and without limitation, wireless connection, radio communication, low power wide area network, optical communication, magnetic, capacitive, or optical coupling, and the like. In some instances, the terminology “communicatively coupled” may be used in place of communicatively connected in this disclosure.

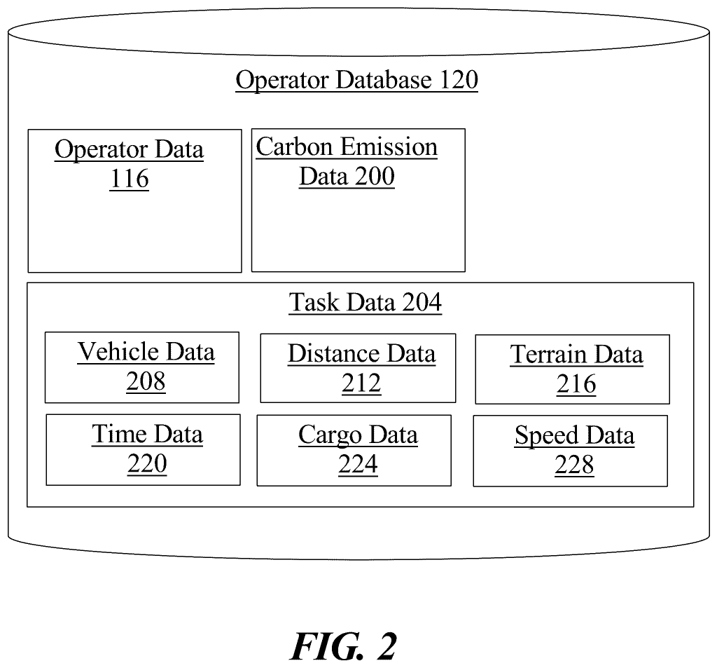

With continued reference to FIG. 1, memory 112 contains instructions configuring processor 108 to receive operator data 116. In some embodiments, operator data 116 may be received from operator database 120. Operator database 120 is further described with reference to FIG. 2. For the purposes of this disclosure, “operator data” is data concerning the historical performance of an operator. An “operator,” for the purposes of this disclosure, is a person that uses a transport vehicle. The transport vehicle may be used to transport objects from one location to another. Objects may include, as non-limiting examples, cargo, goods, produces, livestock, non-fungible goods, fungible goods, produce, cargo containers, oil, liquids, gasoline, food, meals, people, and the like.

With continued reference to FIG. 1, A “transport vehicle” as used in this disclosure is a machine capable of moving one or more objects between one or more locations. In some embodiments, a transport vehicle may include, but is not limited to, a freight carrier, a truck, a car, a boat, a plane, a motorcycle, and the like. A transport vehicle may be configured to operate through, but is not limited to, air, land, sea, and the like. A transport vehicle may be configured to engage in one or more steps of a transport. In some embodiments, a transport vehicle may engage in pickup, delivery, and/or line haul operations. In some embodiments, a transport vehicle may include, but is not limited to, Less than Truckload (“LTL”) and/or Full Truckload (“FTL”) freight delivery.

With continued reference to FIG. 1, operator data 116 includes at least an operator associated with at least a carbon emission datum 124. A “carbon emission datum,” for the purposes of this disclosure is a datum describing the carbon emission of an operator. In some embodiments, operator data 116 may include greenhouse gas data associated with an operator. “Greenhouse gas data” as used in this disclosure is a metric associated with a pollutant that contributes to the greenhouse effect. A “pollutant” as used in this disclosure is a substance that degrades environmental quality. In some embodiments, greenhouse gas data may include, but is not limited to, carbon emissions, water vapor, methane, nitrous oxide, ozone, chlorofluorocarbons, hydrofluorocarbons, perfluorocarbons, and the like. Greenhouse gas data may include measurements associated with an amount of greenhouse gas generated. Carbon emission datum 124 may include an amount of greenhouse gas generated. An amount of greenhouse gas generated may be represented in, but is not limited to, metric tons, pounds, kilograms, cubic meters, and the like. As a non-limiting example, greenhouse gas data may include data showing 4 metric tons of carbon have been generated by an operator. In some embodiments, greenhouse gas data may include data from one or more pollutant sources. A “pollutant source” as used in this disclosure is any originating source of a pollutant. A pollutant source may include, but is not limited to, transport vehicles, power grids, combustion from boilers, furnaces, transport vehicle emissions, emissions from processes performed by or products manufactured by a transport vehicle, and the like. In some embodiments, carbon emission. In some embodiments, carbon emission datum 124 may be a component of greenhouse gas data; that is, carbon emission datum 124 may include a portion of greenhouse gas data pertaining to carbon emissions.

Still referring to FIG. 1, carbon emission datum 124 and/or greenhouse gas data may be represented in energy and/or fuel consumed by a transport vehicle, total fuel consumed of a transport, and the like. Fuel may include, but is not limited to, gasoline, diesel, propane, liquefied natural gas, and/or other fuel types. In some embodiments, a transport vehicle may use alternative fuel. An “alternative fuel” as used in this disclosure is any energy source generated without a use of fossils. A “fossil” as used in this disclosure is preserved remains of any once-living organism. Alternative fuels may include, but are not limited to, nuclear power, compressed air, hydrogen power, bio-fuel, vegetable oil, propane, and the like. In the instance of alternative fuel, an energy conversion factor may be included. In some embodiments, an energy conversion factor may include, but is not limited to, gallons to electric equivalent for a hybrid or electric transport vehicle. Greenhouse gas data may be consistent with any greenhouse gas data disclosed in U.S. patent application Ser. No. 17/749,535, filed on May 20, 2022, and entitled “SYSTEM AND METHOD FOR GREENHOUSE GAS TRACKING,” the entirety of which is incorporated by reference herein in its entirety.

Still referring to FIG. 1, in some embodiments, carbon emission datum 124 may be calculated from fuel consumption data. For the purposes of this disclosure, “fuel consumption data” is data pertaining to amounts of fuel consumed over a period of time. The period of time may be, as a non-limiting example, the career of an operator. As another non-limiting example, the period of time may be the last 3 days, 1 week, 3 months, 2 years, and the like. As another non-limiting example, the period of time may be the period of time it took to complete a particular task. As a non-limiting example, if a task took 5 hours to complete, the period of time may correspond to those 5 hours. A “task,” for the purposes of this disclosure is an item of work. In some embodiments, the task may be a task that is to be done or has been done by an operator. In some embodiments, the task may be a job for an operator, which includes moving one or more objects from one location to another. In some embodiments, the task may be a job for an operator, which includes moving one or more objects from one location to another using a transport vehicle. In some embodiments, the task may be a job for an operator to do using a transport vehicle.

Still referring to FIG. 1, in some embodiments, carbon emission datum 124 may be calculated from mileage data. For the purposes of this disclosure, “mileage data” is data pertaining to a number of miles traversed by a transport vehicle. Mileage data may be measured in miles, kilometers, feet, yards, furlongs, leagues, and/or any other suitable distance unit. Mileage data may be measured over a period of time. The period of time may be, as a non-limiting example, the career of an operator. As another non-limiting example, the period of time may be the last 3 days, 1 week, 3 months, 2 years, and the like. As another non-limiting example, the period of time may be the period of time it took to complete a particular task. As a non-limiting example, if a task took 5 hours to complete, the period of time may correspond to those 5 hours. In some embodiments, other types of data may be used to calculate carbon emission datum 124 such as type of fuel, idling time, traffic data, and the like. A person of ordinary skill in the art would appreciate, after having reviewed the entirety of this disclosure, that a variety of data could be used in addition to or in place of the data mentioned here in order to calculate the carbon emission datum 124.

With continued reference to FIG. 1, in some embodiments, carbon emission datum may be calculated using a lookup table. A “lookup table,” for the purposes of this disclosure, is an array of data that maps input values to output values. A lookup table may be used to replace a runtime computation with an array indexing operation. As a non-limiting example, a carbon emission lookup table may relate fuel consumption data to carbon emission datum 124. As a non-limiting example, computing device 104 may be configured to “lookup” a given fuel consumption datum in order to find a corresponding carbon emission datum 124. As a non-limiting example, computing device 104 may be configured to “lookup” a given mileage datum in order to find a corresponding carbon emission datum 124.

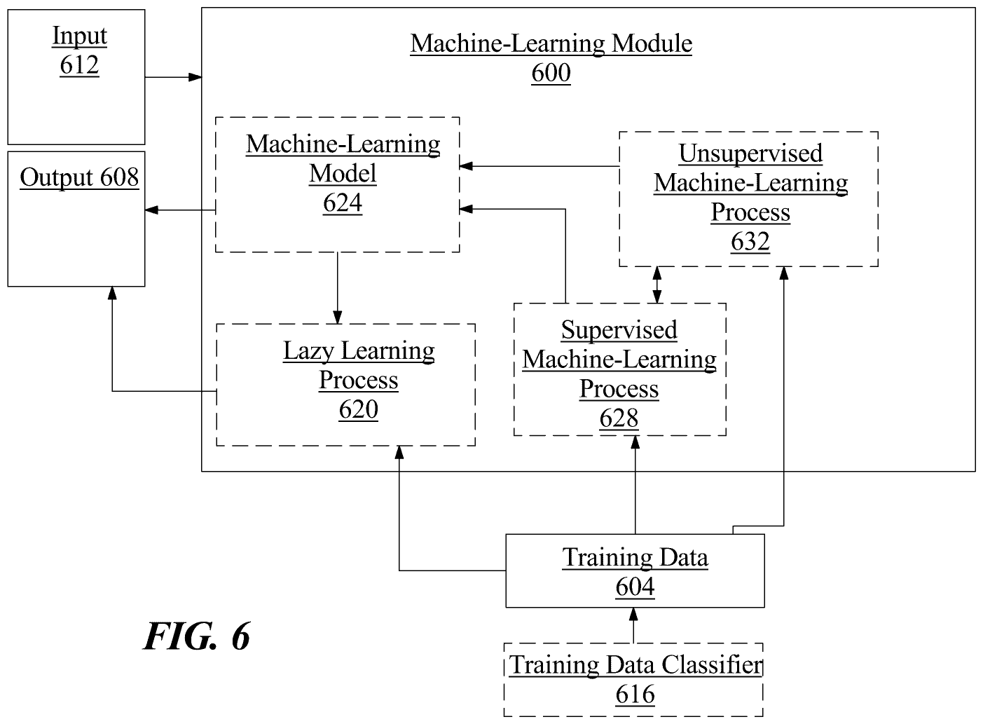

With continued reference to FIG. 1, in some embodiments, computing device 104 may use a carbon emission machine-learning model to calculate carbon emission datum 124. Carbon emission machine-learning model may be created using a machine-learning module 128. Machine-learning module 128 may be consistent with any machine-learning module disclosed as part of this disclosure; particularly, machine-learning module may be consistent with machine-learning module 600 disclosed with reference to FIG. 6.

With continued reference to FIG. 1, in some embodiments, carbon emission machine-learning model may be trained using carbon emission training data. Carbon emission training data may include a plurality of examples of fuel consumption data and/or mileage data with associated carbon emission datums. In some embodiments, carbon emission training data may also include fuel type, traffic data, or other types of data that are correlated to carbon emissions.

With continued reference to FIG. 1, in some embodiments, carbon emission datum 124 may be calculated using one or more rates. As a non-limiting example, a fuel emission rate may be used to calculate carbon emission datum 124 from a fuel consumption datum. In some embodiments, fuel emission rate may represent an amount of carbon emission per volume of fuel used. Fuel emission rate may be stored in a database and retrieved by computing device 104. As a non-limiting example, a mileage emission rate may be used to calculate carbon emission datum 124 from a mileage datum. In some embodiments, mileage rate may represent an amount of carbon emission per distance traveled. Mileage rate may be stored in a database and retrieved by computing device 104.

With continued reference to FIG. 1, in some embodiments, operator data 116 may include a task datum. For the purposes of this disclosure, a “task datum” is an element of data associated with a task. In some embodiments, task datum may be associated with the at least a carbon emission data. Task datum may be an element of task data. Task data may include, as non-limiting examples, vehicle data, distance data, terrain data, time data, cargo data, speed data, fuel data, traffic data, route data, and the like. Task data is disclosed further with reference to FIG. 2. In some embodiments, the task datum may comprise a vehicle datum. For the purposes of this disclosure, a “vehicle datum” is an element of data concerning the type of transport vehicle. In some embodiments, vehicle datum may pertain to the transport vehicle that was used to accomplish the relevant task. Vehicle datum may include a type of vehicle, such as, as non-limiting examples, a truck, a car, a tractor, a motorcycle, a bike, and the like. In some embodiments, vehicle datum may include a make of vehicle, such as VOLVO, MACK, PETERBILT, FORD, BMW, YAMAHA, and the like. In some embodiments, vehicle datum may include a model of vehicle, such as LR, TERRAPRO, F150, PRIUS, IMPALA, and the like. In some embodiments, vehicle datum may include a mile per gallon rating for a vehicle such as, 24 mpg, 30 mpg, 17, mpg, and the like. In some embodiments, the task datum may comprise a distance datum. For the purposes of this disclosure, a “distance datum” is an element of data concerning the amount of distance traversed during a task. As non-limiting examples, distance datum may be 50 miles, 10 miles, 5 miles, and the like. Distance datum may be expressed in any suitable distance unit, including but not limited to miles, kilometers, feet, yards, furlongs, leagues, and the like.

With continued reference to FIG. 1, in some embodiments, carbon emission datum 124 may include a plurality of carbon emission datums 124. In some embodiments, each of the plurality of carbon emission datums 124 may be associated with a task datum. As a non-limiting example, a first carbon emission datum 124 may be associated with a first task datum, a second carbon emission datum 124 may be associated with a second task datum, and so on.

With continued reference to FIG. 1, memory 112 contains instructions configuring processor 108 to calculate a carbon emission rate 132 of the at least an operator associated with operator data 116 as a function of the at least a carbon emission datum 124. For the purposes of this disclosure, a “carbon emission rate” is a measurement of carbon emissions measured against another quantity. In some embodiments, calculating carbon emission rate 132 may be as a function of a task datum. As a non-limiting example, carbon emission rate 132 may be calculated as a function of distance datum. In some embodiments, carbon emission rate 132 may be a measurement of carbon emissions over distance. In some embodiments, carbon emission rate 132 may be expressed in units of weight (or mass) over distance. As non-limiting examples, carbon emission rate 132 may be expressed in lbs./mi, kg/m, tons/km, and the like. In some embodiments, carbon emission rate 132 may be calculated as a function of time datum. For the purposes of this disclosure, a “time datum,” is a datum describing the amount of time that a task took to complete. In some embodiments, carbon emission rate 132 may be a measurement of carbon emissions over time. In some embodiments, carbon emission rate 132 may be expressed in units of weight (or mass) over time. As non-limiting examples, carbon emission rate 132 may be expressed in lbs./min, kg/hr., tons/hr., and the like. In some embodiments, carbon emission rate 132 may be calculated as a function of cargo datum. In some embodiments, carbon emission rate 132 may be a measurement of carbon emissions over cargo weight. In some embodiments, this may be a ratio. In some embodiments, carbon emission rate 132 may be expressed in units of weight (or mass) over cargo weight (or mass). As non-limiting examples, carbon emission rate 132 may be expressed in tons/lb., lbs./lbs., kg/kg, kg/g, and the like.

With continued reference to FIG. 1, in some embodiments, calculating carbon emission rate 132 may include calculating a plurality of carbon emission rates from a plurality of carbon emission datums. In some embodiments, calculating carbon emission rate 132 may include calculating a carbon emission rate 132 for each of a plurality of tasks that an operator has conducted. In some embodiments, calculating carbon emission rate 132 may include calculating a carbon emission rate 132 for each operator of a plurality of operators. In some embodiments, calculating carbon emission rate 132 may include calculating a carbon emission rate 132 for each vehicle of a plurality of vehicles. This may be done, for example, when task datum includes a vehicle datum. As a non-limiting example, this may include calculating a carbon emission rate 132 for each vehicle that an operator uses.

With continued reference to FIG. 1, memory 112 contains instructions configuring processor 108 to calculate a carbon efficiency score 136 of an operator as a function of the carbon emission rate 132. For the purposes of this disclosure, a “carbon efficiency score” is a score that represents an operator's carbon efficiency. In some embodiments, carbon efficiency score 136 may represent an operator's carbon efficiency over a single task. In some embodiments, the carbon efficiency score 136 may represent an operator's carbon efficiency over a plurality of tasks. In some embodiments, carbon efficiency score 136 may represent an operator's carbon efficiency of a certain type of class of tasks. As a non-limiting example, carbon efficiency score 136 may represent an operator's carbon efficiency when using a certain type of transport vehicle, such as the type of transport vehicle indicated by vehicle data. As a non-limiting example, carbon efficiency score 136 may represent an operator's carbon efficiency when transporting a certain type of cargo. In some embodiments, the type of cargo may be a category of cargo as disclosed above. In some embodiments, the type of cargo may be a weight (or mass) of the cargo, such as under 500 lbs., 500 lbs to a ton, 1 ton-3 tons, over 3 tons, and the like. In some embodiments, this information may be attained from a cargo datum. For the purposes of this disclosure, a “cargo datum” is a datum describing cargo transported during a task. In some embodiments, carbon efficiency score 136 may represent an operator's carbon efficiency when traversing a certain terrain, such as a terrain indicated by a terrain datum. For the purposes of this disclosure, a “terrain datum” is a datum describing the terrain traversed during a task. As a non-limiting example, the terrain may be a surface type, such as paved, dirt, gravel, ice, and the like. As a nonlimiting example, the terrain may be a total elevation change. As non-limiting examples, the total elevation change may be under 500 ft, 500 ft-1500 ft, over 1500 ft, −500 ft to 500 ft, and the like.

With continued reference to FIG. 1, in some embodiments, memory 112 may contain instructions configuring processor 108 to train a carbon efficiency machine-learning model 140. In some embodiments, processor 108 may use machine-learning module 128 to train carbon efficiency machine-learning model 140. Training carbon efficiency machine-learning model 140 may include training carbon efficiency machine-learning model 140 using carbon efficiency training data 144. Carbon efficiency training data 144 may include a plurality of inputs correlated to a plurality of outputs.

With continued reference to FIG. 1, the “inputs” for carbon efficiency training data 144 may include carbon emission data and task data. In some embodiments, carbon efficiency training data 144 may include examples of carbon emission data. In some embodiments, carbon efficiency training data 144 may include examples of carbon emission data and associated examples of task data. In some embodiments, carbon efficiency training data 144 may include examples of carbon emission rate 132. In some embodiments, carbon efficiency training data 144 may include examples of carbon emission rate 132 and associated examples of carbon emission datum 124 and task data.

With continued reference to FIG. 1, the “outputs” for carbon efficiency training data 144 may include examples of carbon efficiency scores which are correlated to inputs of carbon efficiency training data 144. As a non-limiting example, carbon efficiency training data 144 may include a carbon emission rate 132 associated with a carbon efficiency score 136. As another non-limiting example, carbon efficiency training data 144 may include carbon emission datums 124 and task data associated with a carbon efficiency score 136. As another non-limiting example, carbon efficiency training data 144 may include carbon emission rate 132 and task data associated with a carbon efficiency score 136.

With continued reference to FIG. 1, in some embodiments, tasks may be classified into task categories. Task categories may include, as non-limiting examples, heavy-load tasks, mountainous tasks, wide load tasks, and the like. In some embodiments, task categories may correspond to types of tasks with differing expected carbon emissions. As a non-limiting example, tasks that are “mountainous” or contain long periods of altitude change may be expected to have higher carbon emissions. On the other hand, tasks with little to no elevation change may be expected to have lower expected carbon emissions. As another non-limiting example, tasks with low variance in transport vehicle speed may have lower expected carbon emissions. On the other hand, tasks with high variance in transport vehicle speed (which may arise in high-traffic areas) may have higher expected carbon emissions.

With continued reference to FIG. 1, in some embodiments, tasks may be classified into task categories using a task classifier. A “task classifier,” for the purposes of this disclosure, is a classifier configured to sort tasks into task categories. Classifiers are discussed further with reference to FIG. 6. Task classifier may receive data concerning a task, such as task data as input, and may output a task category for the task. Task classifier may be trained by machine-learning module 128. In some embodiments, task classifier may be trained using training data containing sets of task data with associated task categories. In some embodiments, task classifier may be trained using training data containing sets of task data correlated to associated carbon emission datum 124 or carbon emission rate 132. In these embodiments, task classifier may be trained to group tasks with similar carbon emission datum 124 or carbon emission rate 132 into like task categories. In some embodiments, task categories may be used to calculate carbon efficiency score. As a non-limiting example, if a task is associated with higher carbon emissions, the carbon efficiency score may be increased or augmented to account for this fact. As a non-limiting example, if a task is associated with lower carbon emissions, the carbon efficiency score may be decreased or discounted to account for this fact. In some embodiments, the task data used to train carbon efficiency machine-learning model 140 may include associated task categories. In some embodiments, carbon efficiency machine-learning model 140 may receive as input task data including associated task categories.

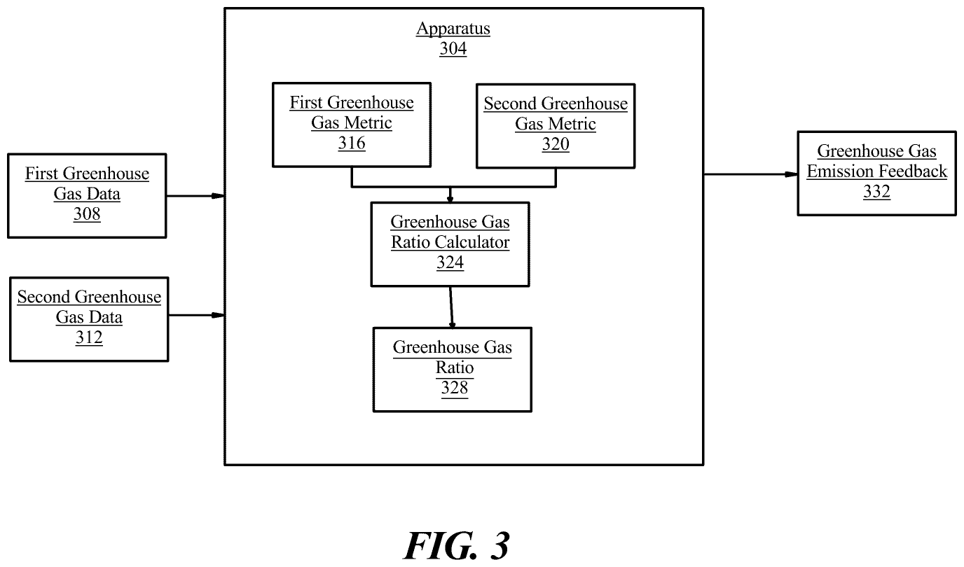

With continued reference to FIG. 1, in some embodiments, memory 112 may contain instructions configuring processor 108 to calculate a greenhouse gas ratio. The calculation of a greenhouse gas ratio is discussed further with reference to FIG. 3.

With continued reference to FIG. 1, memory 112 may contain instructions configuring processor 108 to generate an operator ranking 148. For the purposes of this disclosure, an “operator ranking” is an ordered list of operators. The operator ranking 148 is a function of the carbon efficiency score 136 of an operator. As a non-limiting example, operator ranking 148 may include an ordered list of operators, wherein the list is ordered based on the carbon efficiency score 136 of the operators. In some embodiments, operator ranking 148 may be ordered in a decreasing order, such that the operator with the largest carbon efficiency score 136 is listed first and the operator with the smallest carbon efficiency score 136 is listed last. In some embodiments, operator ranking 148 may be ordered in an ascending order, such that the operator with the smallest carbon efficiency score 136 is listed first and the operator with the largest carbon efficiency score is listed last.

With continued reference to FIG. 1, computing device 104 may display operator ranking 148 on a display device. A “display device,” for the purposes of this disclosure, is a device that is capable of displaying data in a visual manner. Display device may include, as non-limiting examples, a television, a computer monitor, an LCD screen, an OLED screen, a CRT screen, and the like. Display device may be communicatively connected to computing device 104. In some embodiments, display device may be local (located on the same network) to computing device 104. In some embodiments, display device may be remote (located on a different network) to computing device 104. In some embodiments, operator ranking 148 may include operator data 116 associated with each operator in operator ranking 148. As non-limiting example, operator ranking 148 may include the names, pictures, employment history, age, and the like of operators in operator ranking 148.

With continued reference to FIG. 1, computing device 104 may transmit operator ranking 148 to a remote device. For the purposes of this disclosure, a “remote device” is a computing device that is located remotely to computing device 104. As non-limiting examples, remote device may include a laptop, smartphone, tablet, desktop, and the like. In some embodiments, once remote device has received operator ranking 148, remote device may display operator ranking using a remote display device. Remote display device may be consistent with display device as disclosed in this disclosure. In some embodiments, computing device 104 may command remote device to display operator ranking 148.

With continued reference to FIG. 1, in some embodiments, memory 112 may contain instructions further configuring processor 108 to generate a forecasted carbon efficiency score 152. Generating the forecasted carbon efficiency score is a function of operator data 116 and a forecasted task. Forecasted task may be consistent with tasks as disclosed in this disclosure. For the purposes of this disclosure, a “forecasted task” is a task that has not occurred yet. In some embodiments, forecasted task may be a task that a company is scheduled to conduct at some point in the future. In some embodiments, forecasted task may be a purely hypothetical task.

With continued reference to FIG. 1, in some embodiments, generating forecasted carbon efficiency score 152 may include training a forecast machine-learning model 156. In some embodiments, machine-learning module 128 may be used to train forecast machine-learning model 156. In some embodiments, forecast machine-learning model 156 may be trained using operator training data 160. In some embodiments, operator training data 160 may include past operator data and past task data correlated to carbon efficiency data. As a non-limiting example past task data may include task data for previous tasks that have been completed by the operator for which the forecasted carbon efficiency score 152 is being generated. In some embodiments, past task data may include task data corresponding to tasks that the operator has completed. In some examples, operator training data 160 may include past operator data and past task data correlated to carbon efficiency scores. In some embodiments, forecast machine-learning model 156 may be trained on training data corresponding to a specific operator. In some embodiments, this specific operator may be the operator for which forecasted carbon efficiency score is being generated. In some embodiments, forecast machine-learning model may be trained using training data from a variety of operators, such as some or all of the operators working for a company.

With continued reference to FIG. 1, in some embodiments, forecast machine-learning model 156 may be used to generate the forecasted carbon efficiency score 152. Forecast machine-learning model 156 may take operator data 116 and forecasted task data as input. Forecast machine-learning model 156 may output a forecasted carbon efficiency score 152. In some embodiments, forecast machine-learning model 156 may generate a forecasted carbon efficiency score 152 for an operator. In some embodiments, forecast machine-learning model 156 may output a plurality of forecasted carbon efficiency score 152 wherein each of the plurality of forecasted carbon efficiency score 152 corresponds to an operator of a plurality of operators. Forecast machine-learning model 156 may be implemented using any methodology as described below in more detail in reference to FIG. 6.

With continued reference to FIG. 1, in some embodiments, carbon efficiency machine-learning model 140, operator training data 160, and/or task training data may be received from a training data database. Training data database may be implemented, without limitation, as a relational training data database, a key-value retrieval training data database such as a NOSQL training data database, or any other format or structure for use as a database that a person skilled in the art would recognize as suitable upon review of the entirety of this disclosure. Training data database may alternatively or additionally be implemented using a distributed data storage protocol and/or data structure, such as a distributed hash table or the like. Training data database may include a plurality of data entries and/or records as described above. Data entries in a training data database may be flagged with or linked to one or more additional elements of information, which may be reflected in data entry cells and/or in linked tables such as tables related by one or more indices in a relational database. Persons skilled in the art, upon reviewing the entirety of this disclosure, will be aware of various ways in which data entries in a database may store, retrieve, organize, and/or reflect data and/or records as used herein, as well as categories and/or populations of data consistently with this disclosure.

With continued reference to FIG. 1, in some embodiments, training data database may be an employee database. An “employee database,” for the purposes of this disclosure is a database of employee data maintained by an employer. For the purposes of this disclosure, an employee database may also include information regarding independent contractors, agents, and the like. In some embodiments, employee database may include information regarding a plurality of employees, as well as task data concerning the tasks completed by those employees. In some embodiments, employee database may also include carbon emission data regarding the tasks of the employees.

With continued reference to FIG. 1, in some embodiments, memory 112 may contain instructions configuring the processor 108 to select an operator of the at least an operator. Any operators that are selected may be part of operator selection 164. In some embodiments, this may be as a function of the carbon efficiency score 136. For example, the operator with the highest, or otherwise best, carbon efficiency score 136 may be selected. In some embodiments, this may be as a function of the forecasted carbon efficiency score 152. For example, the operator with the highest, or otherwise best, forecasted carbon efficiency score 152 may be selected. In some embodiments, the operator may be selected using operator ranking 148. For example, in some embodiments, the first (or last) placed operator in operator ranking 148 may be selected.

With continued reference to FIG. 1, in some embodiments, memory 112 may contain instructions configuring the processor 108 to display operator selection 164 on a display device. Display device may be consistent with any display device disclosed as part of this disclosure. In some embodiments, memory 112 may contain instructions configuring the processor 108 to send operator selection 164 to a remote device. Remote device may be consistent with any remote device disclosed as part of this disclosure.

Referring now to FIG. 2, a diagram of an exemplary embodiment of operator database 120 is shown. Operator database 120 may be implemented, without limitation, as a relational database, a key-value retrieval database such as a NOSQL database, or any other format or structure for use as a database that a person skilled in the art would recognize as suitable upon review of the entirety of this disclosure. Operator database 120 may alternatively or additionally be implemented using a distributed data storage protocol and/or data structure, such as a distributed hash table or the like. Operator database 120 may include a plurality of data entries and/or records as described above. Data entries in a database may be flagged with or linked to one or more additional elements of information, which may be reflected in data entry cells and/or in linked tables such as tables related by one or more indices in a relational database. Persons skilled in the art, upon reviewing the entirety of this disclosure, will be aware of various ways in which data entries in a database may store, retrieve, organize, and/or reflect data and/or records as used herein, as well as categories and/or populations of data consistently with this disclosure.

With continued reference to FIG. 2, operator database 120 may include operator data 116. Operator data 116 in some embodiments, may include identifying information an operator or plurality of operators. Identifying information may include, a name, a photograph, a job title, an employee number, a license plate number, a social security number, and the like.

With continued reference to FIG. 2, in some embodiments, operator database 120 may include carbon emission data 200. In some embodiments, operator data 116 may include carbon emission data 200. Carbon emission data 200 may include a plurality of carbon emission datum 124. As a non-limiting example, in some embodiments, operator data 116 may include carbon emission data 200 associated with one or more operators.

With continued reference to FIG. 2, in some embodiments, operator database 120 may include carbon emission data 200. In some embodiments, operator data 116 may include carbon emission data 200. As a non-limiting example, in some embodiments, operator data 116 may include carbon emission data 200 associated with various tasks completed by operators in operator data 116. As a non-limiting example, operator data 116 may include carbon emission data 200 associated with an operator, wherein the carbon emission data 200 may include data concerning one or more tasks completed by that operator.

With continued reference to FIG. 2, carbon emission data 200 may include a plurality of different data types concerning tasks. A person of ordinary skill in the art, after having read the entirety of this disclosure, would appreciate that carbon emission data 200 may include a variety of different types of data concerning tasks. In some embodiments, carbon emission data 200 may include vehicle data 208. Vehicle data 208 may include a plurality of vehicle datums. Vehicle datums are described further with reference to FIG. 1. In some embodiments, vehicle data 208 may include a type, make, or model of a transport vehicle that was used for a particular task. In some embodiments, carbon emission data 204 may include distance data 212. Distance data 212 may include a plurality of distance datums. Distance datums are further described with reference to FIG. 1. In some embodiments, carbon emission data 200 may include terrain data 216. Terrain data 216 may include a plurality of terrain datums. Terrain datums are further described with reference to FIG. 1. In some embodiments, carbon emission data 200 may include time data 220. Time data 220 may include a plurality of time datums. Time datums. Time datums are further described with reference to FIG. 1. In some embodiments, carbon emission data 200 may include cargo data 224. Cargo data 224 may include a plurality of cargo datums. Cargo datums are further described with reference to FIG. 2. Cargo data 224 may include, as non-limiting examples, the weight of cargo, quantitative data regarding the cargo, qualitative data regarding the cargo, a type of cargo, dimensions of cargo, and the like. In some embodiments, carbon emission data 200 may include speed data 228. For the purposes of this disclosure, “speed data” is data related to the speed of a transport vehicle conducting a task. Speed data 228 may include a plurality of speed datums. As non-limiting examples, speed data 228 may include, average speed, top speed, lowest speed, and the like.

Referring now to FIG. 3, apparatus 304 may be consistent with apparatus 100. Apparatus 304 may be configured to receive first greenhouse gas data 308. Apparatus 304 may receive first greenhouse gas data 308 through an external computing device, user input, and the like. In some embodiments, apparatus 304 may receive first greenhouse gas data 308 through one or more computing devices and/or sensors. In some embodiments, first greenhouse gas data 308 may include, but is not limited to, carbon emissions, water vapor, methane, nitrous oxide, ozone, chlorofluorocarbons, hydrofluorocarbons, perfluorocarbons, and the like. First greenhouse gas data 308 may include measurements associated with an amount of greenhouse gas generated. An amount of greenhouse gas generated may be represented in, but is not limited to, metric tons, pounds, kilograms, cubic meters, and the like. As a non-limiting example, first greenhouse gas data 308 may include data showing 4 metric tons of carbon have been generated by a user. In some embodiments, first greenhouse gas data 308 may include data from one or more pollutant sources. A pollutant source may include, but is not limited to, transport vehicles, power grids, combustion from boilers, furnaces, transport vehicle emissions, emissions from processes performed by or products manufactured by a transport vehicle, and the like. In some embodiments, a transport vehicle may include, but is not limited to, a freight carrier, a truck, a car, a boat, a plane, a motorcycle, and the like. A transport vehicle may be configured to operate through, but is not limited to, air, land, sea, and the like. A transport vehicle may be configured to engage in one or more steps of a transport. In some embodiments, a transport vehicle may engage in pickup, delivery, and/or line haul operations. In some embodiments, a transport vehicle may include, but is not limited to, Less than Truckload (“LTL”) and/or Full Truckload (“FTL”) freight delivery.

Still referring to FIG. 3, in some embodiments, first greenhouse gas data 308 may include data of a pollutant emission source that may not be directly related to a transportation entity. As a non-limiting example, first greenhouse gas data 308 may include data from energy used in electronic invoicing of a transport. A “transportation entity” as used in this disclosure is a being involved in a transportation of a component. In some embodiments, first greenhouse gas data 308 may include degrees of separation from a transportation entity. A “degree of separation” as used in this disclosure is a measure of relation between two or more one entities and/or objects. For instance and without limitation, a degree of separation of first greenhouse gas data 308 may include two degrees of separation from actions of a transportation entity, with a first degree being fuel consumption of a transport vehicle and a second degree being pollution generated from transport component packaging. Greenhouse gas emission sources that may be one degree of separation away from actions of a transportation entity may include, but are not limited to, greenhouse gas emissions produced in generating electricity used during operations related to a transport process. Operations related to a transport process may include, but are not limited to, computational power, conveyor use, manufacturing machine use, crane use, light sources, and the like.

Still referring to FIG. 3, first greenhouse gas data 308 may be represented in energy and/or fuel consumed by a transport vehicle, distance traveled of a transport vehicle, total fuel consumed of a transport, and the like. Fuel may include, but is not limited to, gasoline, diesel, propane, liquefied natural gas, and/or other fuel types. In some embodiments, a transport vehicle may use alternative fuel.

Still referring to FIG. 3, apparatus 304 may be configured to receive second greenhouse gas data 312. “Second greenhouse gas data” as used in this disclosure is a metric associated with a pollutant source. In some embodiments, second greenhouse gas data 312 may include data of an identical greenhouse gas emission source of first greenhouse gas data 308. In other embodiments, second greenhouse gas data 312 may include data from a different greenhouse gas emission source than first greenhouse gas data 308. In some embodiments, apparatus 304 may be configured to receive first greenhouse gas data 308 and/or second greenhouse gas data 312 from an external computing device, such as, but not limited to, a desktop, laptop, smartphone, server, and the like. In some embodiments, first greenhouse gas data 308 and/or second greenhouse gas data 312 may be generated from an on-board computing device of a transport vehicle.

Still referring to FIG. 3, apparatus 304 may be configured to calculate first greenhouse gas metric 316. A “greenhouse gas metric” as used in this disclosure is a metric pertaining to a pollutant emission contributing to the greenhouse effect. First greenhouse gas metric 316 may be calculated as a function of first greenhouse gas data 308. In some embodiments, first greenhouse gas metric 316 may include an amount of emission generated. An amount of emission generated may include, but is not limited to, volumes, weights, masses, ratios, and the like. In some embodiments, first greenhouse gas metric 316 may include a measurement pertaining to a specific user. In some embodiments, first greenhouse gas metric 316 may include data of an amount of emission generated by a specific user. In some embodiments, first greenhouse gas metric 316 may include data of a type of emission generated by a user. In some embodiments, first greenhouse gas metric 316 may include data of a ratio of emission generated by a user. A ratio may include, but is not limited to, user emissions to average emissions, pollution emissions to clean energy emissions, and the like.

Still referring to FIG. 3, apparatus 304 may be configured to calculate second greenhouse gas metric 320. “Second greenhouse gas metric” as used in this disclosure is any measurement pertaining to an auxiliary emission of pollutant of a user. In some embodiments, apparatus 304 may calculate second greenhouse gas metric 320 as a function of second greenhouse gas data 312. In some embodiments, second greenhouse gas metric 320 may be generated from a plurality of metrics. Second greenhouse gas metric 320 may include a measurement of an indirect source of pollutant emission, such as, but not limited to, distance traveled of a transport vehicle, transport type, invoicing, new hires, electricity used, and the like. In some embodiments, second greenhouse gas metric 320 may include, but is not limited to, a plurality of utility resources that are expended during a transport including water, electricity and other forms of energy consumed or expended by the transport vehicle. Second greenhouse gas metric 320 may include, but is not limited to, generation of electricity, a consumption of natural gas, propane, and oil. In some embodiments, second greenhouse gas metric 320 may include data of an aerial transport. An aerial transport may include, but is not limited to, an aircraft, helicopter, plane, drone, and the like. In some embodiments, data of an aerial transport may include distances traveled via aerial transport. In some embodiments, second greenhouse gas metric 320 may include manual data entered and/or recorded by a computing system of a transporter. In some embodiments, second greenhouse gas metric 320 may include emissions during a loading of components, such as a loading of components in a transport vehicle. In some embodiments, second greenhouse gas metric 320 may include emissions generated by equipment used in loading components to be transported. Equipment may include any machine configured to move one or more components. Equipment may include, but is not limited to, a forklift or other equipment used at a shipping terminal. In some embodiments, second greenhouse gas metric 320 may include utility expenditures associated with buildings and/or structures that may be associated with a transport vehicle and/or transport. In some embodiments, a first plurality of inputs may include an amount of fuel consumption and/or a number of miles driven by at least one vehicle associated with a freight carrier.

Still referring to FIG. 3, apparatus 304 may include greenhouse gas ratio calculator 324. Greenhouse gas ratio calculator 324 may include any computing system as described in this disclosure. Greenhouse gas ratio calculator 324 may be configured to apportion a greenhouse gas emission with a pollutant source. In some embodiments, greenhouse gas ratio calculator 324 may be configured to receive first greenhouse gas metric 316 and/or second greenhouse gas metric 320. Greenhouse gas ratio calculator 324 may be configured to determine an estimation of greenhouse gas emissions from first greenhouse gas metric 316 and/or second greenhouse gas metric 320. In some embodiments, greenhouse gas ratio calculator 324 may determine a conversion factor. A “conversion factor” as used in this disclosure is any ratio of energy used to greenhouse gas generated. In some embodiments, a conversion factor may include a carbon conversion rate for Liquefied Natural Gas (“LNG”), Kilowatts (“KW”), Diesel fuel, Compressed Natural Gas (“CNG”), Gasoline, biodiesel fuel, and/or air power. Determining greenhouse gas ratio 328 may include applying a conversion factor for fuel consumed by a transport vehicle and/or applying a conversion factor for a distance traveled by a transport. A “greenhouse gas ratio” as used in this disclosure is a proportion of a metric of a pollutant source to greenhouse gas emissions. In some embodiments, examples of a metric may include, but are not limited to, gallons of gasoline, diesel, or biodiesel fuel and number of miles driven by a vehicle. In some embodiments, a conversion factor for miles driven may be available from sources such as the Environmental Protection Agency (“EPA”). In some embodiments, a conversion factor may include grams of a GHG gas, such as carbon, emitted on a per mile basis. In some embodiments, a conversion factor may include a ratio of a pollutant emission to a greenhouse gas, such as, but not limited to, ozone, carbon, methane, propane, and the like. One of ordinary skill in the art would understand, after reviewing this disclosure in its entirety, how to determine a proper conversion factor to use for the calculation.

Still referring to FIG. 3, first greenhouse gas metric 316 and/or second greenhouse gas metric 320 may be calculated by apparatus 304 with a conversion factor for a specific natural resource consumed during generation or use of a utility service. In some embodiments, a utility service may include, but is not limited to, natural gas, electricity, water, and/or oil. As a non-limiting example, a utility service may include water heating, sewage systems, lighting systems, heating and cooling systems, and the like. In some embodiments, a conversion factor may be associated with a generation of electricity. Carbon emissions may vary with an amount and type of energy source used in producing electricity. In some embodiments, a conversion factor may be calculated based on a plurality of factors such as, but not limited to, location, time of year, type of resource consumed during a generation of electricity, and the like. In some embodiments, a grid mix for a particular location may determine a conversion factor or factors that may be used. A type of resource consumed may include, but is not limited to, coal, natural gas, and/or other material that may be burned or used up during a generation of electricity. Additionally, renewable resources may be used during the generation of electricity and may allow for an offset of some carbon emissions that may be caused by a use of other resources.

Still referring to FIG. 3, in some embodiments, a transport may include a plurality of components. In some embodiments, a plurality of components may include, but is not limited to, consumer goods. In some embodiments, each component of a plurality of components may be associated with one or more users. A user may include a transport recipient. Apparatus 304 may be configured to allocate an amount of greenhouse gas produced during a transport to a user based on a plurality of factors. In some embodiments, an amount of greenhouse gas produced may be allocated to a user based on factors such as, but not limited to, weight, volume, and/or fuel consumed during a transport of the plurality of components. This allocation process may be repeated based on multiple transports to provide a user with a total amount of carbon emissions associated with a user for a predetermined time period, such as, but not limited to, a year, month, week, and the like. In some embodiments, a portion of a total carbon amount may be allocated to a plurality of users. For instance and without limitation, a transport may include four transport recipients at four varying destinations. Apparatus 304 may determine that a transport has a total greenhouse gas emission of 24 metric tons of carbon. Apparatus 304 may be configured to determine a contribution of greenhouse gas emissions by each of the four transport recipients. Apparatus 304 may determine a first transport recipient contributed 4 metric tons of carbon emissions, a second transport recipient contributed 12 metric tons of carbon emissions, a third transport recipient contributed 6 metric tons of carbon emissions, and a fourth transport recipient contributed 2 metric tons of carbon emissions to a total carbon emission of a transport. Each determination of a contributed greenhouse gas emission of each transport recipient may be calculated by apparatus 304 through factors such as, but not limited to, transport component weight, transport component quantity, transport distance, transport routes, transport component packaging, electronic invoicing, and the like.

Still referring to FIG. 3, in some embodiments, a first greenhouse gas data 308 and/or a second greenhouse gas data 312 may be stored in a database. A database may include, but is not limited to, Enterprise Resource Planning (“ERP”) databases, invoices records and/or other data sources. In some embodiments, a database may store and retrieve information automatically. In other embodiments, a database may be configured to receive manual inputs from a user. In other embodiments, information may be imported to a database. In some embodiments, a distance traveled, and/or energy consumed may be stored as transport vehicle miles and gallons of fuel consumed in separate databases for different transport vehicle categories. In some embodiments, a database may store information for a car category and a truck category separately. In other embodiments, a database may store carbon emission data of a car category and a truck category together. A database may include data from an ERP database. In some embodiments, a database may include airline transportation invoices. In some embodiments, a database may include utility data, transport invoices, and/or other data.

Still referring to FIG. 3, apparatus 304 may include an objective function. An “objective function” as used in this disclosure is a process of minimizing or maximizing one or more values based on a set of constraints. Apparatus 304 may generate an objective function to optimize a greenhouse gas emission of a transport. In some embodiments, an objective function of apparatus 304 may include an optimization criterion. An optimization criterion may include any description of a desired value or range of values for one or more attributes of a transport; desired value or range of values may include a maximal or minimal value, a range between maximal or minimal values, or an instruction to maximize or minimize an attribute and/or a threshold value. As a non-limiting example, an optimization criterion may specify that a greenhouse gas emission of a transport should be less than 3 metric tons; an optimization criterion may cap a greenhouse gas emission of a transport, for instance specifying that a transport must not have a greenhouse gas emission greater than a specified value. An optimization criterion may specify one or more desired transport criteria. In an embodiment, an optimization criterion may assign weights to different attributes or values associated with attributes; weights, as used herein, may be multipliers or other scalar numbers reflecting a relative importance of a particular attribute or value. One or more weights may be expressions of value to a user of a particular outcome, attribute value, or other facet of a transport; value may be expressed, as a non-limiting example, in remunerative form, such as a material quality, a quickest transport, or the like. As a non-limiting example, minimization of greenhouse gas emissions may be multiplied by a first weight, while tolerance above a certain value may be multiplied by a second weight. Optimization criteria may be combined in weighted or unweighted combinations into a function reflecting an overall outcome desired by a user; a function may be a greenhouse gas emission function to be minimized and/or maximized. A function may be defined by reference to transport criteria constraints and/or weighted aggregation thereof as provided by apparatus 304; for instance, a greenhouse gas emissions function combining optimization criteria may seek to minimize or maximize a function of greenhouse gas emissions.

Still referring to FIG. 3, apparatus 304 may use an objective function to compare first greenhouse gas metric 316 and/or second greenhouse gas metric 320 with an ideal greenhouse gas metric. An “ideal greenhouse gas metric” as used in this disclosure is an optimal value of pollutant emissions. An ideal greenhouse gas metric may include, but is not limited to, a range of a quantity of pollutant emissions. For instance and without limitation, an ideal greenhouse gas metric may include a range of about between 1 to 5 metric tons of carbon. Generation of an objective function may include generation of a function to score and weight factors to achieve a process score for each feasible pairing. In some embodiments, pairings may be scored in a matrix for optimization, where columns represent transports and rows represent greenhouse gas emissions potentially paired therewith; each cell of such a matrix may represent a score of a pairing of the corresponding transport to the corresponding greenhouse gas emission. In some embodiments, assigning a predicted process that optimizes the objective function includes performing a greedy algorithm process. A “greedy algorithm” is defined as an algorithm that selects locally optimal choices, which may or may not generate a globally optimal solution. For instance, apparatus 304 may select pairings so that scores associated therewith are the best score for each order and/or for each process. In such an example, optimization may determine the combination of processes such that each object pairing includes the highest score possible.

Still referring to FIG. 3, an objective function may be formulated as a linear objective function. Apparatus 304 may solve an objective function using a linear program such as without limitation a mixed-integer program. A “linear program,” as used in this disclosure, is a program that optimizes a linear objective function, given at least a constraint. For instance, and without limitation, objective function may seek to maximize a total score Σ_{r∈R}Σ_{s∈S}cᵣₛxᵣₛ, where R is a set of all transports r, S is a set of all greenhouse gas emissions s, cᵣₛ is a score of a pairing of a given transport with a given greenhouse gas emission, and xᵣₛ is 1 if a transport r is paired with a greenhouse gas emission s, and 0 otherwise. Continuing the example, constraints may specify that each transport is assigned to only one greenhouse gas emission, and each greenhouse gas emission is assigned only one transport. Matches may include matching processes as described above. Sets of processes may be optimized for a maximum score combination of all generated processes. In various embodiments, apparatus 304 may determine a combination of transports that maximizes a total score subject to a constraint that all transports are paired to exactly one greenhouse gas emission. Not all transports may receive a greenhouse gas emission pairing since each greenhouse gas emission may only pair to one transport. In some embodiments, an objective function may be formulated as a mixed integer optimization function. A “mixed integer optimization” as used in this disclosure is a program in which some or all of the variables are restricted to be integers. A mathematical solver may be implemented to solve for the set of feasible pairings that maximizes the sum of scores across all pairings; mathematical solver may be implemented on apparatus 304 and/or another device in apparatus 100, and/or may be implemented on third-party solver.

With continued reference to FIG. 3, optimizing an objective function may include minimizing a loss function, where a “loss function” is an expression an output of which an optimization algorithm minimizes to generate an optimal result. As a non-limiting example, apparatus 304 may assign variables relating to a set of parameters, which may correspond to score components as described above, calculate an output of mathematical expression using the variables, and select a pairing that produces an output having the lowest size, according to a given definition of “size,” of the set of outputs representing each of plurality of candidate ingredient combinations; size may, for instance, included absolute value, numerical size, or the like. Selection of different loss functions may result in identification of different potential pairings as generating minimal outputs. Objectives represented in an objective function and/or loss function may include minimization of transport times. Objectives may include minimization of greenhouse gas emissions. Objectives may include minimization of long idle times. Objectives may include minimization of cost. Objectives may include minimization of resources used.

Still referring to FIG. 3, apparatus 304 may determine one or more factors contributing to first greenhouse gas metric 316 and/or second greenhouse gas metric 320. As a non-limiting example, apparatus 304 may determine a transport to a user includes a long travel time as first greenhouse gas metric 316 and a large amount of fuel consumed as a second greenhouse gas metric 320. Apparatus 304 may also determine a plurality of other contributing factors, such as, but not limited to, long idle percentages, amounts of stops in a transport, transport weight, transport path efficiency, and the like. Apparatus 304 may compare two or more contributing factors using an objective function to minimize an amount of greenhouse gas produced. As a non-limiting example, apparatus 304 may compare a transport distance to a number of stops in a transport path. Apparatus 304 may determine that a total amount of greenhouse gas produced by a transport may be offset by reducing a number of stops in the transport. Apparatus 304 may utilize a machine learning model to predict greenhouse gas generation of a transport. A machine learning model may be trained on training data correlating transport factors to greenhouse gas generation. A machine learning model may be configured to input transport factors and output estimated greenhouse gas emissions. In some embodiments, apparatus 304 may be configured to estimate greenhouse gas emissions of particular users, transports, individual contributing factors, and the like.

Still referring to FIG. 3, apparatus 304 may be configured to display, but is not limited to displaying, greenhouse gas data, greenhouse gas metrics, greenhouse gas ratios, and the like to a user. In some embodiments, apparatus 304 may display greenhouse gas data and/or metrics through a graphical user interface (GUI). In some embodiments, apparatus 304 may be configured to display greenhouse gas data to a user through, but not limited to, a smartphone, tablet, desktop, laptop, and the like. Apparatus 304 may display alternative options for a transport of a user.

Still referring to FIG. 3, in some embodiments, apparatus 304 may be configured to provide greenhouse gas emission feedback 332 through a display as a function of a calculation of greenhouse gas ratio 328. “Greenhouse gas emission feedback” as used in this disclosure is information pertaining to greenhouse gas emissions of an individual, object, and/or entity. Greenhouse gas emission feedback 332 may include, without limitation, historical trends, daily emissions, hourly emissions, and the like. In some embodiments, greenhouse gas emission feedback 332 may include a comparison of a user to one or more other users. For instance, and without limitation, a user may drive inefficiently, causing an extra 0.4 metric tons of greenhouse gas emissions. A second user may drive efficiently, causing no extra greenhouse gas emissions. Greenhouse gas emission feedback 332 may show a first user a comparison of a second user driving efficiently and/or may show steps to increase driving efficiency of the first user. Greenhouse gas emission feedback 332 may include a greenhouse gas reduction plan. Apparatus 304 may generate a greenhouse gas reduction plan as a function of a tracking of a transport. A “greenhouse gas reduction plan” as used in this disclosure is a step or steps of preventing excessive pollutant emissions. A greenhouse gas reduction plan may be generated for a transport recipient, which may include, but is not limited to, recommended fuel types, transport times, fewer transport component packages, less frequent transports, and the like. For instance, and without limitation, apparatus 304 may present a greenhouse gas reduction plan to a user through an external computing device, such as a smartphone, laptop, desktop, and the like. A greenhouse gas reduction plan generated for a transport recipient may include environmentally friendly options such as using alternate fuels, using recyclable materials, using biodegradable packaging, and the like. Apparatus 304 may display an estimated amount of greenhouse gas emissions reduced through selecting environmentally friendly options of a greenhouse gas reduction plan. In some embodiments, apparatus 304 may be configured to generate costs associated with choosing environmentally friendly options, such as, but not limited to, costs of fuel, costs of transport component packaging, costs of transport duration, and the like.

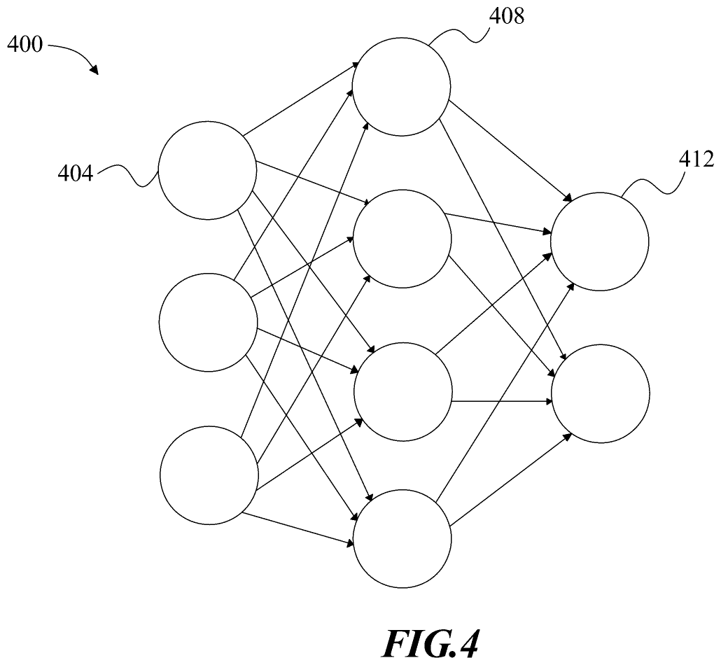

Referring now to FIG. 4, an exemplary embodiment of neural network 400 is illustrated. A neural network 400 also known as an artificial neural network, is a network of “nodes,” or data structures having one or more inputs, one or more outputs, and a function determining outputs based on inputs. Such nodes may be organized in a network, such as without limitation a convolutional neural network, including an input layer of nodes 404, one or more intermediate layers 408, and an output layer of nodes 412. Connections between nodes may be created via the process of “training” the network, in which elements from a training dataset are applied to the input nodes, a suitable training algorithm (such as Levenberg-Marquardt, conjugate gradient, simulated annealing, or other algorithms) is then used to adjust the connections and weights between nodes in adjacent layers of the neural network to produce the desired values at the output nodes. This process is sometimes referred to as deep learning. Connections may run solely from input nodes toward output nodes in a “feed-forward” network, or may feed outputs of one layer back to inputs of the same or a different layer in a “recurrent network.” As a further non-limiting example, a neural network may include a convolutional neural network comprising an input layer of nodes, one or more intermediate layers, and an output layer of nodes. A “convolutional neural network,” as used in this disclosure, is a neural network in which at least one hidden layer is a convolutional layer that convolves inputs to that layer with a subset of inputs known as a “kernel,” along with one or more additional layers such as pooling layers, fully connected layers, and the like.

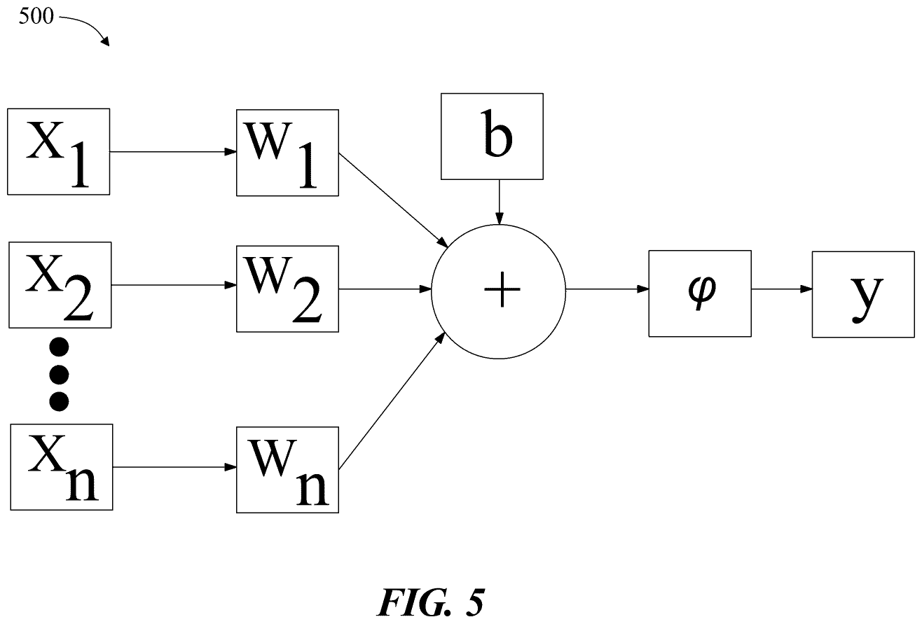

Referring now to FIG. 5, an exemplary embodiment of a node of a neural network is illustrated. A node may include, without limitation a plurality of inputs xᵢ that may receive numerical values from inputs to a neural network containing the node and/or from other nodes. Node may perform a weighted sum of inputs using weights wᵢ that are multiplied by respective inputs xᵢ. Additionally or alternatively, a bias b may be added to the weighted sum of the inputs such that an offset is added to each unit in the neural network layer that is independent of the input to the layer. The weighted sum may then be input into a function φ, which may generate one or more outputs y. Weight wᵢ applied to an input xᵢ may indicate whether the input is “excitatory,” indicating that it has strong influence on the one or more outputs y, for instance by the corresponding weight having a large numerical value, and/or a “inhibitory,” indicating it has a weak effect influence on the one more inputs y, for instance by the corresponding weight having a small numerical value. The values of weights wᵢ may be determined by training a neural network using training data, which may be performed using any suitable process as described above.

Referring now to FIG. 6, an exemplary embodiment of a machine-learning module 600 that may perform one or more machine-learning processes as described in this disclosure is illustrated. Machine-learning module may perform determinations, classification, and/or analysis steps, methods, processes, or the like as described in this disclosure using machine learning processes. A “machine learning process,” as used in this disclosure, is a process that automatedly uses training data 604 to generate an algorithm that will be performed by a computing device/module to produce outputs 608 given data provided as inputs 612; this is in contrast to a non-machine learning software program where the commands to be executed are determined in advance by a user and written in a programming language.

Still referring to FIG. 6, “training data,” as used herein, is data containing correlations that a machine-learning process may use to model relationships between two or more categories of data elements. For instance, and without limitation, training data 604 may include a plurality of data entries, each entry representing a set of data elements that were recorded, received, and/or generated together; data elements may be correlated by shared existence in a given data entry, by proximity in a given data entry, or the like. Multiple data entries in training data 604 may evince one or more trends in correlations between categories of data elements; for instance, and without limitation, a higher value of a first data element belonging to a first category of data element may tend to correlate to a higher value of a second data element belonging to a second category of data element, indicating a possible proportional or other mathematical relationship linking values belonging to the two categories. Multiple categories of data elements may be related in training data 604 according to various correlations; correlations may indicate causative and/or predictive links between categories of data elements, which may be modeled as relationships such as mathematical relationships by machine-learning processes as described in further detail below. Training data 604 may be formatted and/or organized by categories of data elements, for instance by associating data elements with one or more descriptors corresponding to categories of data elements. As a non-limiting example, training data 604 may include data entered in standardized forms by persons or processes, such that entry of a given data element in a given field in a form may be mapped to one or more descriptors of categories. Elements in training data 604 may be linked to descriptors of categories by tags, tokens, or other data elements; for instance, and without limitation, training data 604 may be provided in fixed-length formats, formats linking positions of data to categories such as comma-separated value (CSV) formats and/or self-describing formats such as extensible markup language (XML), JavaScript Object Notation (JSON), or the like, enabling processes or devices to detect categories of data.

Alternatively or additionally, and continuing to refer to FIG. 6, training data 604 may include one or more elements that are not categorized; that is, training data 604 may not be formatted or contain descriptors for some elements of data. Machine-learning algorithms and/or other processes may sort training data 604 according to one or more categorizations using, for instance, natural language processing algorithms, tokenization, detection of correlated values in raw data and the like; categories may be generated using correlation and/or other processing algorithms. As a non-limiting example, in a corpus of text, phrases making up a number “n” of compound words, such as nouns modified by other nouns, may be identified according to a statistically significant prevalence of n-grams containing such words in a particular order; such an n-gram may be categorized as an element of language such as a “word” to be tracked similarly to single words, generating a new category as a result of statistical analysis. Similarly, in a data entry including some textual data, a person's name may be identified by reference to a list, dictionary, or other compendium of terms, permitting ad-hoc categorization by machine-learning algorithms, and/or automated association of data in the data entry with descriptors or into a given format. The ability to categorize data entries automatedly may enable the same training data 604 to be made applicable for two or more distinct machine-learning algorithms as described in further detail below. Training data 604 used by machine-learning module 600 may correlate any input data as described in this disclosure to any output data as described in this disclosure. As a non-limiting illustrative example carbon emission rate 132 and carbon efficiency score 136 or carbon emission rate 132 and forecasted carbon efficiency score 152

Further referring to FIG. 6, training data may be filtered, sorted, and/or selected using one or more supervised and/or unsupervised machine-learning processes and/or models as described in further detail below; such models may include without limitation a training data classifier 616. Training data classifier 616 may include a “classifier,” which as used in this disclosure is a machine-learning model as defined below, such as a mathematical model, neural net, or program generated by a machine learning algorithm known as a “classification algorithm,” as described in further detail below, that sorts inputs into categories or bins of data, outputting the categories or bins of data and/or labels associated therewith. A classifier may be configured to output at least a datum that labels or otherwise identifies a set of data that are clustered together, found to be close under a distance metric as described below, or the like. Machine-learning module 600 may generate a classifier using a classification algorithm, defined as a processes whereby a computing device and/or any module and/or component operating thereon derives a classifier from training data 604. Classification may be performed using, without limitation, linear classifiers such as without limitation logistic regression and/or naive Bayes classifiers, nearest neighbor classifiers such as k-nearest neighbors classifiers, support vector machines, least squares support vector machines, fisher's linear discriminant, quadratic classifiers, decision trees, boosted trees, random forest classifiers, learning vector quantization, and/or neural network-based classifiers. As a non-limiting example, training data classifier 616 may classify elements of training data to a task type, vehicle type, or operator type.

Still referring to FIG. 6, machine-learning module 600 may be configured to perform a lazy-learning process 620 and/or protocol, which may alternatively be referred to as a “lazy loading” or “call-when-needed” process and/or protocol, may be a process whereby machine learning is conducted upon receipt of an input to be converted to an output, by combining the input and training set to derive the algorithm to be used to produce the output on demand. For instance, an initial set of simulations may be performed to cover an initial heuristic and/or “first guess” at an output and/or relationship. As a non-limiting example, an initial heuristic may include a ranking of associations between inputs and elements of training data 604. Heuristic may include selecting some number of highest-ranking associations and/or training data 604 elements. Lazy learning may implement any suitable lazy learning algorithm, including without limitation a K-nearest neighbors algorithm, a lazy naïve Bayes algorithm, or the like; persons skilled in the art, upon reviewing the entirety of this disclosure, will be aware of various lazy-learning algorithms that may be applied to generate outputs as described in this disclosure, including without limitation lazy learning applications of machine-learning algorithms as described in further detail below.

Alternatively or additionally, and with continued reference to FIG. 6, machine-learning processes as described in this disclosure may be used to generate machine-learning models 624. A “machine-learning model,” as used in this disclosure, is a mathematical and/or algorithmic representation of a relationship between inputs and outputs, as generated using any machine-learning process including without limitation any process as described above, and stored in memory; an input is submitted to a machine-learning model 624 once created, which generates an output based on the relationship that was derived. For instance, and without limitation, a linear regression model, generated using a linear regression algorithm, may compute a linear combination of input data using coefficients derived during machine-learning processes to calculate an output datum. As a further non-limiting example, a machine-learning model 624 may be generated by creating an artificial neural network, such as a convolutional neural network comprising an input layer of nodes, one or more intermediate layers, and an output layer of nodes. Connections between nodes may be created via the process of “training” the network, in which elements from a training data 604 set are applied to the input nodes, a suitable training algorithm (such as Levenberg-Marquardt, conjugate gradient, simulated annealing, or other algorithms) is then used to adjust the connections and weights between nodes in adjacent layers of the neural network to produce the desired values at the output nodes. This process is sometimes referred to as deep learning.

Still referring to FIG. 6, machine-learning algorithms may include at least a supervised machine-learning process 628. At least a supervised machine-learning process 628, as defined herein, include algorithms that receive a training set relating a number of inputs to a number of outputs, and seek to find one or more mathematical relations relating inputs to outputs, where each of the one or more mathematical relations is optimal according to some criterion specified to the algorithm using some scoring function. For instance, a supervised learning algorithm may include inputs as described in this disclosure as inputs, outputs as described above in this disclosure as outputs, and a scoring function representing a desired form of relationship to be detected between inputs and outputs; scoring function may, for instance, seek to maximize the probability that a given input and/or combination of elements inputs is associated with a given output to minimize the probability that a given input is not associated with a given output. Scoring function may be expressed as a risk function representing an “expected loss” of an algorithm relating inputs to outputs, where loss is computed as an error function representing a degree to which a prediction generated by the relation is incorrect when compared to a given input-output pair provided in training data 604. Persons skilled in the art, upon reviewing the entirety of this disclosure, will be aware of various possible variations of at least a supervised machine-learning process 628 that may be used to determine relation between inputs and outputs. Supervised machine-learning processes may include classification algorithms as defined above.

Further referring to FIG. 6, machine learning processes may include at least an unsupervised machine-learning processes 632. An unsupervised machine-learning process, as used herein, is a process that derives inferences in datasets without regard to labels; as a result, an unsupervised machine-learning process may be free to discover any structure, relationship, and/or correlation provided in the data. Unsupervised processes may not require a response variable; unsupervised processes may be used to find interesting patterns and/or inferences between variables, to determine a degree of correlation between two or more variables, or the like.

Still referring to FIG. 6, machine-learning module 600 may be designed and configured to create a machine-learning model 624 using techniques for development of linear regression models. Linear regression models may include ordinary least squares regression, which aims to minimize the square of the difference between predicted outcomes and actual outcomes according to an appropriate norm for measuring such a difference (e.g. a vector-space distance norm); coefficients of the resulting linear equation may be modified to improve minimization. Linear regression models may include ridge regression methods, where the function to be minimized includes the least-squares function plus term multiplying the square of each coefficient by a scalar amount to penalize large coefficients. Linear regression models may include least absolute shrinkage and selection operator (LASSO) models, in which ridge regression is combined with multiplying the least-squares term by a factor of 1 divided by double the number of samples. Linear regression models may include a multi-task lasso model wherein the norm applied in the least-squares term of the lasso model is the Frobenius norm amounting to the square root of the sum of squares of all terms. Linear regression models may include the elastic net model, a multi-task elastic net model, a least angle regression model, a LARS lasso model, an orthogonal matching pursuit model, a Bayesian regression model, a logistic regression model, a stochastic gradient descent model, a perceptron model, a passive aggressive algorithm, a robustness regression model, a Huber regression model, or any other suitable model that may occur to persons skilled in the art upon reviewing the entirety of this disclosure. Linear regression models may be generalized in an embodiment to polynomial regression models, whereby a polynomial equation (e.g. a quadratic, cubic or higher-order equation) providing a best predicted output/actual output fit is sought; similar methods to those described above may be applied to minimize error functions, as will be apparent to persons skilled in the art upon reviewing the entirety of this disclosure.

Continuing to refer to FIG. 6, machine-learning algorithms may include, without limitation, linear discriminant analysis. Machine-learning algorithm may include quadratic discriminant analysis. Machine-learning algorithms may include kernel ridge regression. Machine-learning algorithms may include support vector machines, including without limitation support vector classification-based regression processes. Machine-learning algorithms may include stochastic gradient descent algorithms, including classification and regression algorithms based on stochastic gradient descent. Machine-learning algorithms may include nearest neighbors algorithms. Machine-learning algorithms may include various forms of latent space regularization such as variational regularization. Machine-learning algorithms may include Gaussian processes such as Gaussian Process Regression. Machine-learning algorithms may include cross-decomposition algorithms, including partial least squares and/or canonical correlation analysis. Machine-learning algorithms may include naïve Bayes methods. Machine-learning algorithms may include algorithms based on decision trees, such as decision tree classification or regression algorithms. Machine-learning algorithms may include ensemble methods such as bagging meta-estimator, forest of randomized trees, AdaBoost, gradient tree boosting, and/or voting classifier methods. Machine-learning algorithms may include neural net algorithms, including convolutional neural net processes.

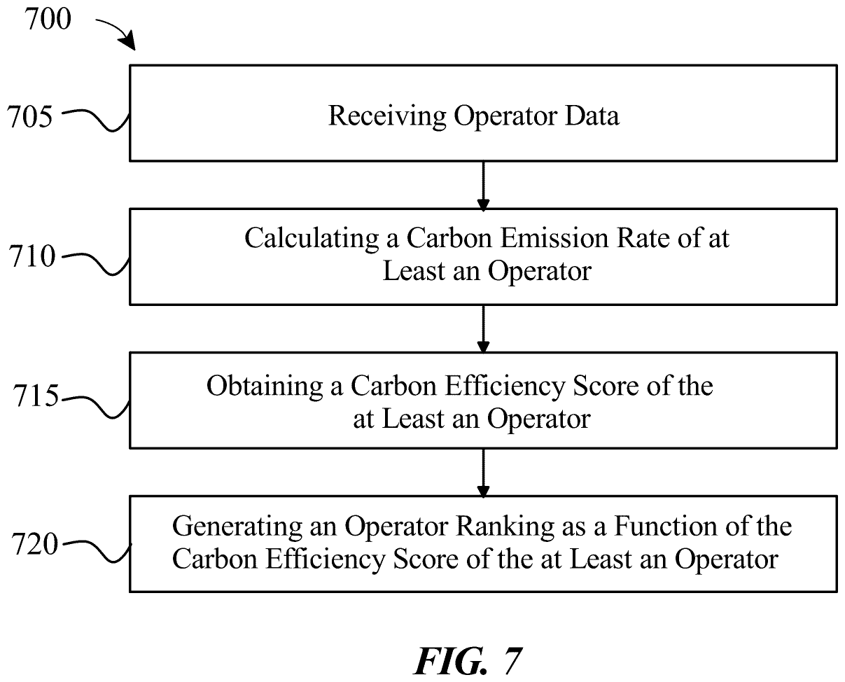

Now referring to FIG. 7, an exemplary embodiment of a method 700 for comparing the efficiency of operators. Method 700 includes a step 705 of receiving, by a processor, operator data, wherein the operator data comprises at least an operator associated with at least a carbon emission datum. This may be implemented as described with reference to FIGS. 1-6. In some embodiments, operator data may include a task datum associated with the at least a carbon emission datum. In some embodiments, the task datum may include a vehicle datum. In some embodiments, the task datum may include a distance datum. In some embodiments, the at least a carbon emission datum may include a plurality of carbon emission datums. In some embodiments, each of the plurality of carbon emission datums may be associated with a task datum.

With continued reference to FIG. 7, method 700 includes a step 710 of calculating, by the processor, a carbon emission rate of the at least an operator as a function of the at least a carbon emission datum. This may be implemented as described with reference to FIGS. 1-6. In some embodiments, step 710 may include calculating the carbon emission rate of the at least an operator comprises calculating the carbon emission rate of the at least an operator as a function of the task datum. This may be implemented as described with reference to FIGS. 1-6. In some embodiments, step 710 may include calculating a plurality of carbon emission rates from the plurality of carbon emission datums. This may be implemented as described with reference to FIGS. 1-6.

With continued reference to FIG. 7, method 700 includes a step 715 of obtaining, by the processor, a carbon efficiency score of the at least an operator as a function of the carbon emission rate. This may be implemented as described with reference to FIGS. 1-6. In some embodiments, step 715 may be a function of the plurality of carbon emission rates.

With continued reference to FIG. 7, method 700 includes a step 720 of generating, by the processor, an operator ranking as a function of the carbon efficiency score of the at least an operator. This may be implemented as described with reference to FIGS. 1-6.

With continued reference to FIG. 7, in some embodiments, method 700 may include a step of generating, by the processor, a forecasted carbon efficiency score of the at least an operator as a function of the operator data and a forecasted task. This may be implemented as described with reference to FIGS. 1-6. In some embodiments, generating the forecasted carbon efficiency score of the at least an operator may include training a forecast machine-learning model using operator training data, wherein the operator training data comprises at least past operator data and past task data correlated to carbon efficiency data. This may be implemented as described with reference to FIGS. 1-6. In some embodiments, generating the forecasted carbon efficiency score of the at least an operator may include generating the forecasted carbon efficiency score of the at least an operator using the forecast machine-learning model. This may be implemented as described with reference to FIGS. 1-6. In some embodiments, method 700 may further include a step of selecting, by the processor, an operator of the at least an operator for a forecasted task as a function of the forecasted carbon efficiency rating. This may be implemented as described with reference to FIGS. 1-6. In some embodiments, method 700 may include a step of training, by the processor a carbon efficiency machine-learning model using carbon efficiency training data, wherein the carbon efficiency training data comprises examples of carbon emission data and associated examples of task data. This may be implemented as described with reference to FIGS. 1-6. In some embodiments, step 715 may include calculating a carbon efficiency score of the at least an operator comprises using the carbon efficiency machine-learning model. This may be implemented as described with reference to FIGS. 1-6.

It is to be noted that any one or more of the aspects and embodiments described herein may be conveniently implemented using one or more machines (e.g., one or more computing devices that are utilized as a user computing device for an electronic document, one or more server devices, such as a document server, etc.) programmed according to the teachings of the present specification, as will be apparent to those of ordinary skill in the computer art. Appropriate software coding can readily be prepared by skilled programmers based on the teachings of the present disclosure, as will be apparent to those of ordinary skill in the software art. Aspects and implementations discussed above employing software and/or software modules may also include appropriate hardware for assisting in the implementation of the machine executable instructions of the software and/or software module.

Such software may be a computer program product that employs a machine-readable storage medium. A machine-readable storage medium may be any medium that is capable of storing and/or encoding a sequence of instructions for execution by a machine (e.g., a computing device) and that causes the machine to perform any one of the methodologies and/or embodiments described herein. Examples of a machine-readable storage medium include, but are not limited to, a magnetic disk, an optical disc (e.g., CD, CD-R, DVD, DVD-R, etc.), a magneto-optical disk, a read-only memory “ROM” device, a random access memory “RAM” device, a magnetic card, an optical card, a solid-state memory device, an EPROM, an EEPROM, and any combinations thereof. A machine-readable medium, as used herein, is intended to include a single medium as well as a collection of physically separate media, such as, for example, a collection of compact discs or one or more hard disk drives in combination with a computer memory. As used herein, a machine-readable storage medium does not include transitory forms of signal transmission.

Such software may also include information (e.g., data) carried as a data signal on a data carrier, such as a carrier wave. For example, machine-executable information may be included as a data-carrying signal embodied in a data carrier in which the signal encodes a sequence of instruction, or portion thereof, for execution by a machine (e.g., a computing device) and any related information (e.g., data structures and data) that causes the machine to perform any one of the methodologies and/or embodiments described herein.

Examples of a computing device include, but are not limited to, an electronic book reading device, a computer workstation, a terminal computer, a server computer, a handheld device (e.g., a tablet computer, a smartphone, etc.), a web appliance, a network router, a network switch, a network bridge, any machine capable of executing a sequence of instructions that specify an action to be taken by that machine, and any combinations thereof. In one example, a computing device may include and/or be included in a kiosk.

FIG. 8 shows a diagrammatic representation of one embodiment of a computing device in the exemplary form of a computer system 800 within which a set of instructions for causing a control system to perform any one or more of the aspects and/or methodologies of the present disclosure may be executed. It is also contemplated that multiple computing devices may be utilized to implement a specially configured set of instructions for causing one or more of the devices to perform any one or more of the aspects and/or methodologies of the present disclosure. Computer system 800 includes a processor 804 and a memory 808 that communicate with each other, and with other components, via a bus 812. Bus 812 may include any of several types of bus structures including, but not limited to, a memory bus, a memory controller, a peripheral bus, a local bus, and any combinations thereof, using any of a variety of bus architectures.

Processor 804 may include any suitable processor, such as without limitation a processor incorporating logical circuitry for performing arithmetic and logical operations, such as an arithmetic and logic unit (ALU), which may be regulated with a state machine and directed by operational inputs from memory and/or sensors; processor 804 may be organized according to Von Neumann and/or Harvard architecture as a non-limiting example. Processor 804 may include, incorporate, and/or be incorporated in, without limitation, a microcontroller, microprocessor, digital signal processor (DSP), Field Programmable Gate Array (FPGA), Complex Programmable Logic Device (CPLD), Graphical Processing Unit (GPU), general purpose GPU, Tensor Processing Unit (TPU), analog or mixed signal processor, Trusted Platform Module (TPM), a floating point unit (FPU), and/or system on a chip (SoC).

Memory 808 may include various components (e.g., machine-readable media) including, but not limited to, a random-access memory component, a read only component, and any combinations thereof. In one example, a basic input/output system 816 (BIOS), including basic routines that help to transfer information between elements within computer system 800, such as during start-up, may be stored in memory 808. Memory 808 may also include (e.g., stored on one or more machine-readable media) instructions (e.g., software) 820 embodying any one or more of the aspects and/or methodologies of the present disclosure. In another example, memory 808 may further include any number of program modules including, but not limited to, an operating system, one or more application programs, other program modules, program data, and any combinations thereof.

Computer system 800 may also include a storage device 824. Examples of a storage device (e.g., storage device 824) include, but are not limited to, a hard disk drive, a magnetic disk drive, an optical disc drive in combination with an optical medium, a solid-state memory device, and any combinations thereof. Storage device 824 may be connected to bus 812 by an appropriate interface (not shown). Example interfaces include, but are not limited to, SCSI, advanced technology attachment (ATA), serial ATA, universal serial bus (USB), IEEE 1394 (FIREWIRE), and any combinations thereof. In one example, storage device 824 (or one or more components thereof) may be removably interfaced with computer system 800 (e.g., via an external port connector (not shown)). Particularly, storage device 824 and an associated machine-readable medium 828 may provide nonvolatile and/or volatile storage of machine-readable instructions, data structures, program modules, and/or other data for computer system 800. In one example, software 820 may reside, completely or partially, within machine-readable medium 828. In another example, software 820 may reside, completely or partially, within processor 804.

Computer system 800 may also include an input device 832. In one example, a user of computer system 800 may enter commands and/or other information into computer system 800 via input device 832. Examples of an input device 832 include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), a touchscreen, and any combinations thereof. Input device 832 may be interfaced to bus 812 via any of a variety of interfaces (not shown) including, but not limited to, a serial interface, a parallel interface, a game port, a USB interface, a FIREWIRE interface, a direct interface to bus 812, and any combinations thereof. Input device 832 may include a touch screen interface that may be a part of or separate from display 836, discussed further below. Input device 832 may be utilized as a user selection device for selecting one or more graphical representations in a graphical interface as described above.

A user may also input commands and/or other information to computer system 800 via storage device 824 (e.g., a removable disk drive, a flash drive, etc.) and/or network interface device 840. A network interface device, such as network interface device 840, may be utilized for connecting computer system 800 to one or more of a variety of networks, such as network 844, and one or more remote devices 848 connected thereto. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network, such as network 844, may employ a wired and/or a wireless mode of communication. In general, any network topology may be used. Information (e.g., data, software 820, etc.) may be communicated to and/or from computer system 800 via network interface device 840.

Computer system 800 may further include a video display adapter 852 for communicating a displayable image to a display device, such as display device 836. Examples of a display device include, but are not limited to, a liquid crystal display (LCD), a cathode ray tube (CRT), a plasma display, a light emitting diode (LED) display, and any combinations thereof. Display adapter 852 and display device 836 may be utilized in combination with processor 804 to provide graphical representations of aspects of the present disclosure. In addition to a display device, computer system 800 may include one or more other peripheral output devices including, but not limited to, an audio speaker, a printer, and any combinations thereof. Such peripheral output devices may be connected to bus 812 via a peripheral interface 856. Examples of a peripheral interface include, but are not limited to, a serial port, a USB connection, a FIREWIRE connection, a parallel connection, and any combinations thereof.

The foregoing has been a detailed description of illustrative embodiments of the invention. Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present invention. Additionally, although particular methods herein may be illustrated and/or described as being performed in a specific order, the ordering is highly variable within ordinary skill to achieve methods, systems, and software according to the present disclosure. Accordingly, this description is meant to be taken only by way of example, and not to otherwise limit the scope of this invention.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

1. An apparatus for comparing the efficiency of operators, the apparatus comprising:
at least a processor; and
a memory communicatively connected to the at least a processor, the memory containing instructions configuring the at least a processor to:
receive fuel consumption data and mileage data associated with a first trip;
calculate at least a carbon emission datum, wherein calculating the at least a carbon emission datum comprises:
training a carbon emission machine learning model wherein the carbon emission machine learning model is trained using carbon emission training data, wherein the carbon emission training data comprises a plurality of correlations between at least a fuel consumption data input and at least a carbon emission datum output;
wherein training the carbon emission machine learning model further comprises:
detecting additional correlations between the at least a fuel consumption data input and the at least a carbon emission datum output;
generating the at least a carbon emission datum as a function of the carbon emission machine learning model;
receive operator data, wherein the operator data comprises:
at least an operator associated with the at least a carbon emission datum; and
a task datum associated with the at least a carbon emission datum;
classify the task datum into one or more task categories using a task classifier;
calculate a carbon emission rate of the at least an operator as a function of the at least a carbon emission datum and the one or more task categories wherein the carbon emission rate comprises at least a cargo datum wherein the at least a cargo datum comprises a description of the at least a cargo datum;
calculate an ideal greenhouse gas metric associated with the one or more task categories as a function of the carbon emission rate and the carbon emission machine-learning model;
obtain a carbon efficiency score of the at least an operator as a function of the carbon emission rate and the ideal greenhouse gas metric;
generate an operator ranking as a function of the carbon efficiency score of the at least an operator;
select an operator of the at least an operator as a function of the operator ranking;
generate a greenhouse gas emission feedback for the selected operator, wherein the greenhouse gas emission feedback includes a greenhouse gas reduction plan; and
display the operator selection and the greenhouse gas emission feedback on a display device.

2. The apparatus of claim 1, wherein the memory contains instructions further configuring the processor to generate a forecasted carbon efficiency score of the at least an operator as a function of the operator data and a forecasted task.

3. The apparatus of claim 2, wherein generating the forecasted carbon efficiency score of the operator comprises:
training a forecast machine-learning model using operator training data, wherein the operator training data comprises at least an input containing at least past operator data and past task data correlated to at least an output containing carbon efficiency data; and
generating the forecasted carbon efficiency score of the at least an operator as a function of the trained forecast machine-learning model.

4. The apparatus of claim 3, wherein the memory contains instructions further configuring the processor to select an operator of the at least an operator for a forecasted task as a function of the forecasted carbon efficiency rating.

5. The apparatus of claim 1, wherein:
the memory contains instructions further configuring the at least a processor to train a carbon efficiency machine-learning model using carbon efficiency training data, wherein the carbon efficiency training data comprises inputs containing examples of carbon emission data correlated to outputs containing associated examples of task data; and
obtaining the carbon efficiency score of the at least an operator as a function of the trained carbon efficiency machine-learning model.

6. The apparatus of claim 1, wherein:
the operator data comprises a task datum associated with the at least a carbon emission datum; and
calculating the carbon emission rate of the at least an operator comprises calculating the carbon emission rate of the at least an operator as a function of the task datum.

7. The apparatus of claim 6, wherein the task datum comprises a vehicle datum.

8. The apparatus of claim 6, wherein the task datum comprises a distance datum.

9. The apparatus of claim 1, wherein:
the at least a carbon emission datum comprises a plurality of carbon emission datums;
each of the plurality of carbon emission datums is associated with a task datum; and
calculating the carbon emission rate comprises calculating a plurality of carbon emission rates from the plurality of carbon emission datums.

10. The apparatus of claim 9, wherein obtaining the carbon efficiency score further comprises calculating the carbon efficiency score of the at least an operator as a function of the plurality of carbon emission rates.

11. A method for comparing the efficiency of operators, the method comprising:
receiving, by a processor, fuel consumption data and mileage data;
calculating, by the processor, at least a carbon emission datum, wherein calculating the at least a carbon emission datum comprises:
training a carbon emission machine learning model wherein the carbon emission machine learning model is trained using carbon emission training data, wherein the carbon emission training data comprises a plurality of correlations between at least a fuel consumption data input and at least a carbon emission datum output;
wherein training the carbon emission machine learning model further comprises:
detecting additional correlations between the at least a fuel consumption data input and the at least a carbon emission datum output;
generating the at least a carbon emission datum as a function of the carbon emission machine learning model;
receiving, by the processor, operator data, wherein the operator data comprises at least an operator associated with the at least a carbon emission datum and a task datum associated with the at least a carbon emission datum;
classifying, by the processor, the task datum into one or more task categories using a task classifier;
calculating, by the processor, a carbon emission rate of the at least an operator as a function of the at least a carbon emission datum and the task datum wherein the carbon emission rate comprises at least a cargo datum wherein the at least a cargo datum comprises a description of the at least a cargo datum;
calculating, by the processor, an ideal greenhouse gas metric associated with the one or more task categories as a function of the carbon emission rate and the carbon emission machine-learning model;
obtaining, by the processor, a carbon efficiency score of the at least an operator as a function of the carbon emission rate and the ideal greenhouse gas metric; and
generating, by the processor, an operator ranking as a function of the carbon efficiency score of the at least an operator;
selecting, by the processor, an operator of the at least an operator as a function of the operator ranking;
generating, by the processor, a greenhouse gas emission feedback for the selected operator, wherein the greenhouse gas emission feedback includes a greenhouse gas reduction plan; and
displaying, by a display device communicatively connected to the at least a processor, the operator selection, and the greenhouse gas emission feedback.

12. The method of claim 11, further comprising generating, by the processor, a forecasted carbon efficiency score of the at least an operator as a function of the operator data and a forecasted task.

13. The method of claim 12, wherein generating the forecasted carbon efficiency score of the operator comprises:
training a forecast machine-learning model using operator training data, wherein the operator training data comprises at least past operator data and past task data correlated to carbon efficiency data; and
generating the forecasted carbon efficiency score of the at least an operator as a function of the trained forecast machine-learning model.

14. The method of claim 13, further comprising selecting, by the processor, an operator of the at least an operator for a forecasted task as a function of the forecasted carbon efficiency rating.

15. The method of claim 11, wherein:
the method further comprises training, by the processor a carbon efficiency machine-learning model using carbon efficiency training data, wherein the carbon efficiency training data comprises examples of carbon emission data and associated examples of task data; and
wherein obtaining a carbon efficiency score of the at least an operator comprises using the carbon efficiency machine-learning model.

16. The method of claim 11, wherein:
the operator data comprises a task datum associated with the at least a carbon emission datum; and
calculating the carbon emission rate of the at least an operator comprises calculating the carbon emission rate of the at least an operator as a function of the task datum.

17. The method of claim 16, wherein the task datum comprises a vehicle datum.

18. The method of claim 16, wherein the task datum comprises a distance datum.

19. The method of claim 11, wherein:
the at least a carbon emission datum comprises a plurality of carbon emission datums;
each of the plurality of carbon emission datums is associated with a task datum; and
calculating the carbon emission rate comprises calculating a plurality of carbon emission rates from the plurality of carbon emission datums.

20. The method of claim 19, wherein obtaining the carbon efficiency score comprises obtaining the carbon efficiency score of the at least an operator is a function of the plurality of carbon emission rates.
